(19) United States
(12) Patent Application Publication
(10) Pub. No.: US 2010/0320229 A1
(43) Pub. Date: Dec. 23, 2010

(54) Valve construction

(76) Inventor: Barry R. Sendel, Ontario (CA)

Correspondence Address: NIXON & VANDERHYE, PC, 901 NORTH GLEBE ROAD, 11TH FLOOR, ARLINGTON, VA, 22203, US

(21) Appl. No.: 12/457,769

(22) Filed: Jun. 19, 2009

(51) Int. Cl. B67D 1/00; F16K 7/04

(52) U.S. Cl. 222/81; 251/9

(57) ABSTRACT

A valve construction for dispensing liquid from a flexible bag, comprising an elongated hollow valve body with an inwardly tapered head portion on an inner end thereof having apertures in communication with the hollow interior of the valve body, a narrow tip at an inner end of the head portion and an enlarged annular lip facing outwardly on the outer end of the head portion. A locking member is movably mounted on the valve body between a first unlocked position where it is spaced outwardly from the annular lip on the head portion and a second locked position wherein it is in engagement with the annular lip. The valve body can be mounted on a flexible bag by puncturing the bag with the narrow tip of the head portion until surrounding bag material moves over the head portion into engagement with the enlarged annular lip of the head portion, and moving the locking member toward the second locked position wherein it engages the surrounding bag material and compresses it between the locking member and the annular lip to enable liquid within the bag to flow through the apertures in the head portion into the interior of the valve body and to prevent leakage of the liquid between the locking member and the annular lip.

### BACKGROUND OF THE INVENTION

1. Field of the Invention

The present invention relates to a valve construction and, more particularly, to a valve construction for forming and sealing an opening in a flexible bag containing liquid and controlling the flow of liquid therefrom.

2. Description of the Background Art

Flexible bags for liquids have been provided with various types of openings, taps and valves for allowing liquid therein to be dispensed. Although they have generally served their purpose, these flexible bag constructions have been subject to one or more of the following disadvantages:

1. They have been complicated in construction;

2. They have not been reliable in operation;

3. The bag has been formed with a valve that is subject to damage or leakage during transportation of the bag;

4. They have been expensive to manufacture;

5. They have been subject to leakage; and

6. They have been difficult to use.

The valve construction of the present invention is not subject to any of the above-listed disadvantages and is advantageous in that it is separate from the bag and can be used to form and seal an opening in any type of flexible bag and to control the flow of liquid therefrom. Also, the valve construction of the present invention is easy to use, simple in construction, reliable in operation and inexpensive to manufacture.

### BRIEF SUMMARY OF THE INVENTION

The new and improved valve construction of the present invention comprises an elongated body having an inwardly tapered head portion at its inner end that terminates in a narrow tip that is capable of penetrating a flexible bag. The valve body and head portion are hollow, and the outer end of the head portion is provided with one or more apertures in communication with the inner hollow portion thereof.

The valve body comprises a cylindrical portion extending outwardly from and being of less width or diameter than the outer end of the head portion so as to form an annular lip at the outer end of the head portion. The body has an externally threaded portion spaced outwardly from the head portion and a knurled or ridged outer end portion having a flexible tube mounted thereon and in frictional engagement therewith that may be adhesively or otherwise secured thereto.

A generally cylindrical locking member having internal threads is rotatably mounted on the valve body between the head portion and the flexible tube with its internal threads in engagement with the external threads on the body such that the locking member can be rotated and axially moved between an outer position wherein it is in engagement with the inner end of the flexible tube and an inner position wherein an enlarged annular flange on the inner end thereof is in engagement with the annular lip on the outer end of the head portion. To facilitate the rotation of the locking member, it may be provided with one or more radially extending flanges for engagement by the fingers of a user.

The outer end of the flexible tube that extends beyond the outer end of the valve body may be closed in any suitable manner such as by a releasable clip or any other suitable type of flow limiting or control device.

In the use of the valve construction of the present invention, when it is desired to dispense liquid from a flexible bag, the bag is penetrated by the tip of the head portion such that the surrounding bag material moves over the tapered head portion into engagement with the outer annular lip thereof. Thereafter, the locking member is rotated on the valve body so that the enlarged annular flange on the inner end thereof engages the surrounding bag material and compresses it between the inner annular flange of the locking member and the annular lip at the outer end of the head portion to lock the valve construction on the flexible bag and to seal the area of the flexible bag surrounding the opening formed therein by the head portion. Thereafter, liquid can be dispensed from the flexible bag by opening and closing the releasable clip or other flow control device on the flexible tube. The liquid flows from the flexible bag through the apertures in the head portion and into the interior of the hollow valve body.

### BRIEF DESCRIPTION OF THE DRAWINGS

FIG. 1 is a perspective view of a first embodiment of the valve construction of the present invention;

FIG. 2 is a side elevational view of the valve construction shown in FIG. 1 with the locking member in an open position;

FIG. 3 is a side elevational view like FIG. 2 with the locking member in a closed position;

FIG. 4 is a perspective view of the valve construction of FIGS. 1-3 wherein it is locked in position on a flexible bag; and

FIG. 5 is a perspective view of a second embodiment of the valve construction of the present invention with a modified flow control device on the outer portion of the flexible tube.

### DETAILED DESCRIPTION OF THE INVENTION

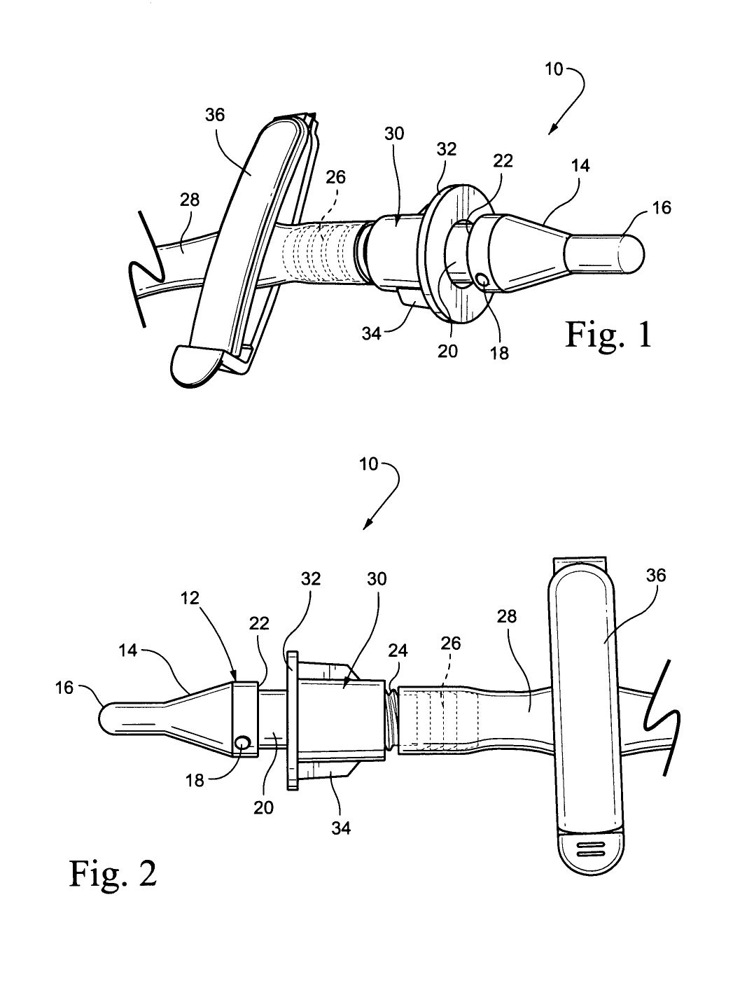

As shown in FIGS. 1-3, the valve construction 10 of the present invention comprises an elongated body 12 having an inwardly tapered head portion 14 at its inner end that terminates in a narrow tip 16 that is capable of penetrating a flexible bag. The valve body 12 and head portion 14 are hollow, and the outer end of the head portion 14 is provided with one or more apertures 18 in communication with the inner hollow portion thereof.

The valve body 12 comprises a generally cylindrical portion 20 extending outwardly from and being of less width or diameter than the outer end of the head portion 14 to form an annular lip 22 at the outer end of the head portion. The valve body 12 has an externally threaded portion 24 spaced outwardly from the head portion 14 and a knurled or ridged outer end portion 26 having a flexible tube 28 mounted thereon and in frictional engagement therewith that may be adhesively or otherwise secured thereto.

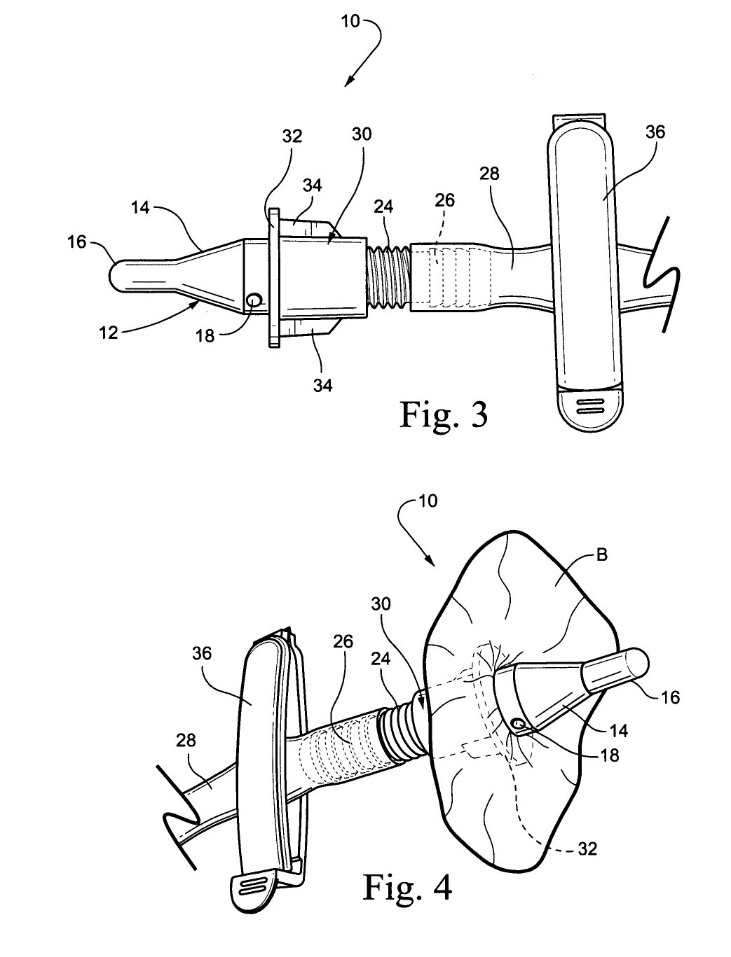

A generally cylindrical locking member 30 having internal threads (not shown) is rotatably mounted on the valve body 12 between the head portion 14 and the flexible tube 28 with its internal threads in engagement with the external threads 24 on the valve body 12 such that the locking member 30 can be rotated and axially moved between an outer position shown in FIGS. 1 and 2, wherein it is in engagement with the inner end of the flexible tube 28, and an inner position shown in FIG. 3, wherein an enlarged annular flange 32 on the inner end of the locking member 30 is in engagement with the annular lip 22 on the outer end of the head portion 14. To facilitate the rotation of the locking member 30, it may be provided with one or more radially extending flanges 34 for engagement by the fingers of a user.

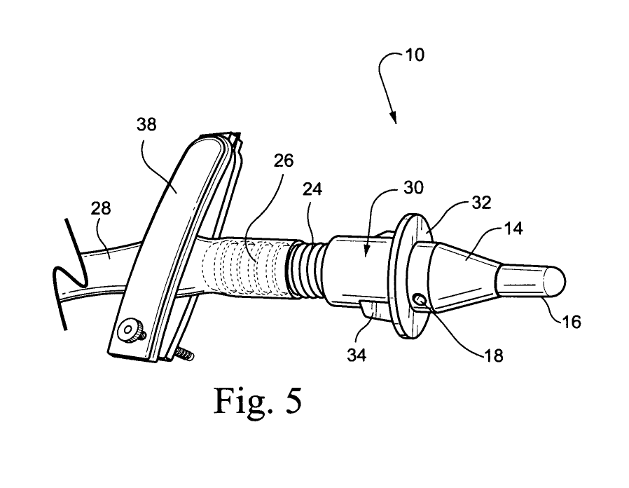

The outer end of the flexible tube 28 that extends beyond the outer end of the valve body 12 may be closed in any suitable manner such as by a releasable clip 36 or any other suitable type of flow limiting or control device. As shown in FIG. 5, the flow limiting or control device may be an adjustable clamp 38.

In the use of the valve construction 10 of the present invention, when it is desired to dispense liquid from a flexible bag B, the bag B is penetrated by the tip of the head portion 14 such that the surrounding bag material moves over the tapered head portion into engagement with the outer annular lip 22, as shown in FIG. 4. Thereafter, the locking member 30 is rotated on the valve body 12 so that the enlarged annular flange 32 on the inner end thereof engages the surrounding bag material and compresses it between the inner annular flange 32 of the locking member 30 and the annular lip 22 at the outer end of the head portion 14 to lock the valve construction 10 on the flexible bag B and to seal the area of the flexible bag B surrounding the opening formed therein by the head portion 14.

Thereafter, liquid can be dispensed from the flexible bag B by opening the releasable clip 36 shown in FIGS. 1-4 or the adjustable clamp 38 shown in FIG. 5. The liquid flows from the flexible bag B through the apertures 18 in the head portion 14 into the interior of the hollow valve body 12 and through the flexible tube 28.

The components of the valve construction 10 of the present invention may be formed of any suitable material such as plastic or metal.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A valve construction for dispensing liquid from a flexible bag or the like, comprising:
an elongated hollow valve body with an inwardly tapered head portion on an inner end thereof, said head portion having apertures in communication with a hollow interior of said valve body, a narrow tip at an inner end of the head portion and an enlarged annular lip facing outwardly on an outer end of the head portion;
a locking member movably mounted on said valve body between a first unlocked position wherein it is spaced outwardly from said annular lip and a second locked position wherein it is in engagement with said annular lip;
wherein said valve body can be mounted on a flexible bag by puncturing the bag with said narrow tip of said head portion until surrounding bag material moves over said head portion into engagement with said enlarged annular lip, and moving said locking member toward said second locked position wherein it engages said surrounding bag material and compresses it between said locking member and said annular lip to enable liquid within the bag to flow through the apertures in said head portion into the interior of said valve body and to prevent leakage of the liquid between said locking member and said annular lip.

2. The valve construction of claim 1 wherein said valve body comprises a device for controlling the flow of liquid therethrough.

3. The valve construction of claim 2 wherein said flow control device comprises a flexible tube connected to an outer end of said valve body, and a device for compressing said tube to control the flow of liquid therethrough.

4. The valve construction of claim 3 wherein said compressing device is a releasable clip.

5. The valve construction of claim 3 wherein said compressing device is an adjustable clamp.

6. The valve construction of claim 1 wherein said locking member has an enlarged annular flange on the inner end thereof for engagement with said annular lip and the surrounding bag material.

7. The valve construction of claim 1 said locking member is rotatably and threadably mounted on said valve body for axial movement between said first unlocked position and said second locked position.

8. The valve construction of claim 7 wherein said locking member has a radial flange to facilitate the gripping and rotation thereof.
